(19) United States
(12) Patent Application Publication
(10) Pub. No.: US 2009/0167206 A1
(43) Pub. Date: Jul. 2, 2009

(54) LIGHTING DEVICE

(75) Inventors: Bernd Ackermann, Aachen (DE); Horst Greiner, Aachen (DE)

Correspondence Address: PHILIPS INTELLECTUAL PROPERTY & STANDARDS, PO BOX 3001, BRIARCLIFF MANOR, NY, 10510-8001, US

(73) Assignee: KONINKLIJKE PHILIPS ELECTRONICS N.V., EINDHOVEN (NL)

(21) Appl. No.: 11/720,668

(22) PCT Filed: Nov. 25, 2005
(86) PCT No.: PCT/IB05/53904

§ 371 Date: Jun. 1, 2007

(30) Foreign Application Priority Data
Dec. 3, 2004 (EP) 04106285.2

(51) Int. Cl. H05B 37/02; F21V 1/00

(52) U.S. Cl. 315/294; 362/235

(57) ABSTRACT

A lighting device (1) having at least two light sources (5), and in particular LED's, having a light distributing device (3) for distributing the light emitted by the light sources (5), the light sources (5) being arranged inside the light distributing device (3), having a diffuser surface (4) arranged on the light distributing device (3) and having at least one separating surface (10) arranged inside the light distributing device (3) to divide the light distributing device (3) into at least two sub-regions (31, 32) for light distribution.

This invention relates to a lighting device of large area having a plurality of light sources and to a sub-dividable arrangement for distributing light.

To produce light of uniform intensity, known lighting devices of large area having a plurality of light sources include a light distributing device and a diffuser surface, which items uniformly distribute or homogeneously mix the light from a plurality of light sources. Electroluminescent light sources (LED's) are typically used in lighting devices of small overall depth. If the light sources emit light of different colors, the lighting device is able to emit white light by means of color mixing. However, within a light distributing device, the perceived color and/or intensity of the light cannot be acted on for one sub-region of the light distributing device independently of the rest of the light distributing device, even if the intensity of each individual light source can be set independently of that of the other light sources.

Document US 2002/0130326 describes a lighting device having a plurality of LED's whose intensities can be set and re-adjusted independently of one another to compensate for time-related effects. This lighting device may comprise a plurality of groups of LED's, in which case the emissions of the groups of LED's can be set independently of one another. The groups may differ in this case in the intensity and/or color of the light from them. It is not possible for the lighting device to be divided into any desired regions of more than group size comprising a plurality of groups of LED's and/or parts of groups of LED's that are also able to emit homogeneous light of different intensities and/or colors in separate regions, independently of one another. Nor is it possible for an individual group of LED's to be divided into any desired sub-regions of LED's or for intensity and color to be settable independently of the other sub-regions of LED's.

It is therefore an object of this invention to make possible a division of lighting devices into sub-regions of any desired shape whose emission characteristics can be set independently of one another, which division is easy, inexpensive and able to be performed at any desired points in time.

This object is achieved by a lighting device having at least two light sources, and in particular LED's, having a light distributing device for distributing the light emitted by the light sources, the light sources being arranged inside the light distributing device, having a diffuser surface arranged on the light distributing device and having at least one separating surface arranged inside the light distributing device to divide the light distributing device into at least two sub-regions for light distribution, which sub-regions may be as desired.

It is advantageous if the separating surface is added to a light distributing device and can be exchanged, thus enabling the division of the lighting device to be flexibly adapted to requirements that vary over time.

To increase the quantity of different light effects that are possible, it is advantageous if at least two light sources are provided to emit light of intensities that can be set independently of one another. It is even more advantageous if, in addition, at least two light sources are provided to emit light in different regions of the spectrum. What is referred to as a “light effect” is an effect produced by the light from the lighting device that differs from the effects of the lighting device when there are no inserted separating surfaces.

It is also advantageous if the separating surface separates the sub-regions in a substantially light-tight manner. Light effects can thus be produced for different sub-regions independently of one another. It is particularly advantageous in this case if the thickness of the separating surface is smaller than the thickness of the diffuser surface. When this is the case, the scattering of light by the diffuser surface is enough to cause the separating surface to appear invisible to the observer. In this embodiment, to the observer, the sub-regions that emit light in different ways border on one another without any visible separation.

For the lighting device to be of small overall depth, it is advantageous if the light distributing device and the separating surface are at least partly composed of materials having a reflectivity of more than 90%, to enable the light emitted by the light sources to be distributed by multiple reflection. For an even smaller overall depth, it is particularly advantageous if there is arranged above the light sources a device that deflects the light emitted by the light sources substantially parallel to the diffuser surface. An even distribution of light in the plane of the light sources that are arranged is obtained in this way, thus enabling the diffuser surface to be arranged very close to the light sources.

To produce special light effects, it is advantageous if the separating surface has regions, such as holes and/or slots for example, that are permeable to light, for an exchange of light between the sub-regions. In this way, the transition between two sub-regions can be differently arranged, as desired by the observer, to be of a different intensity and/or color as dictated by the form taken by the regions permeable to light. It is even more advantageous if the separating surface is so arranged that at least three light sources, and in particular three light sources that emit in different colors, are arranged in each sub-region. By a distribution of the light from three differently colored light sources in a sub-region, light of any desired color, even white light for example, can be obtained for each sub-region.

For the emission of light from a sub-region, it is advantageous if the diffuser surface has a light transmission of between 40% and 60%. In this way, a uniform distribution of intensity of the light emitted by the lighting device will be obtained even in the region of the separating surface.

These and other aspects of the invention are apparent from and will be elucidated with reference to the embodiments described hereinafter.

In the drawings:

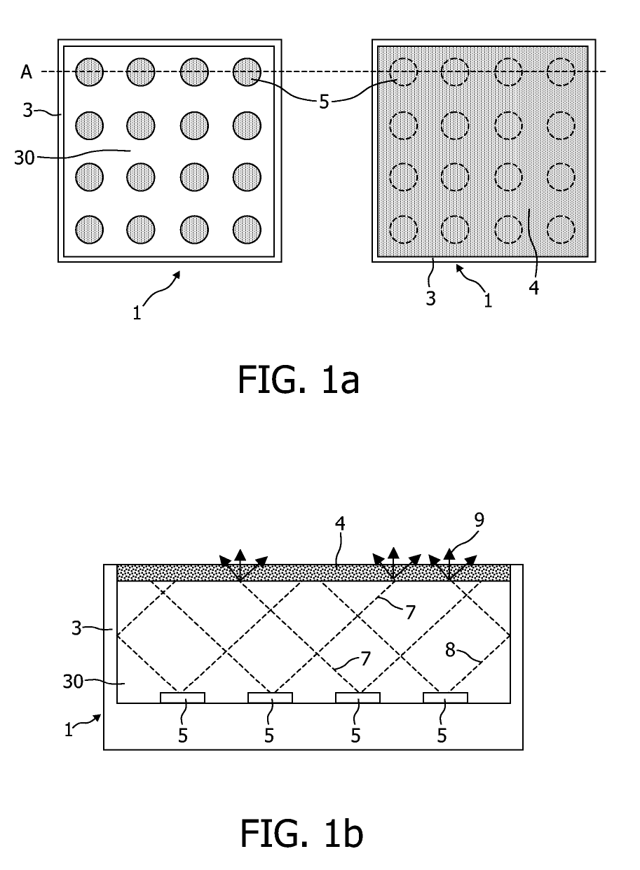

FIG. 1a shows plan views of a lighting device (with and without a diffuser surfaces).

FIG. 1b is a view from the side of a lighting device, in section on plane of section A (FIG. 1a).

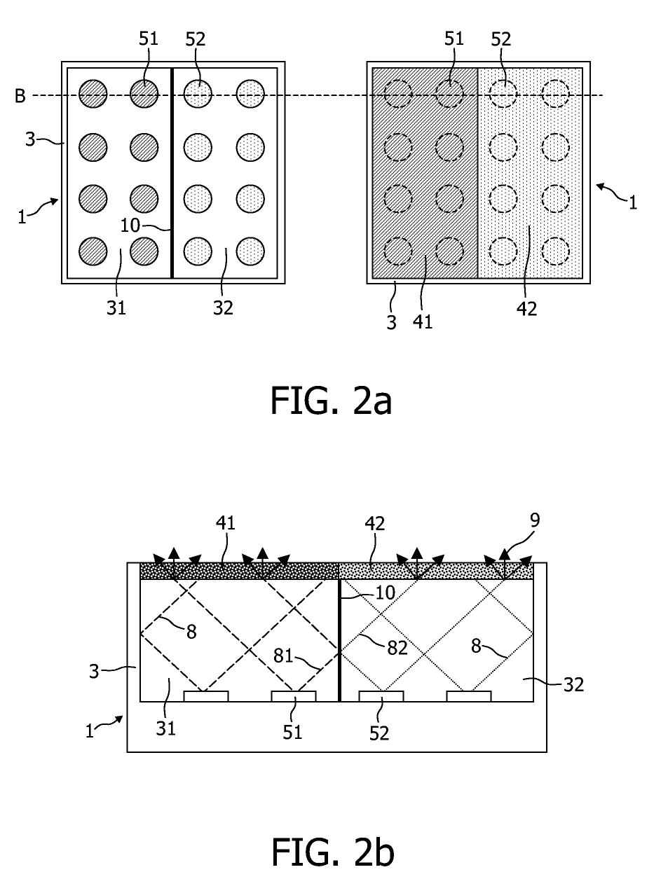

FIG. 2a shows plan views of a lighting device according to the invention having a separating surface (with and without a diffuser surface).

FIG. 2b is a view from the side of a lighting device according to the invention having a separating surface, in section on plane of section B (FIG. 2a).

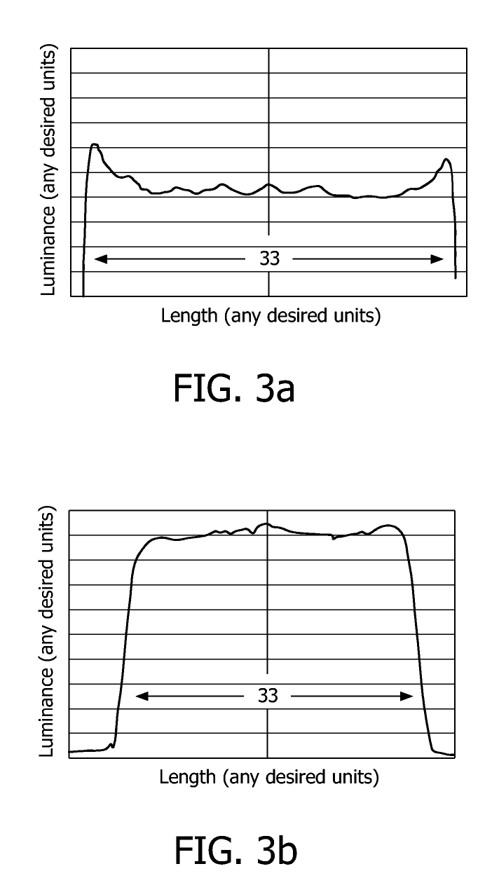

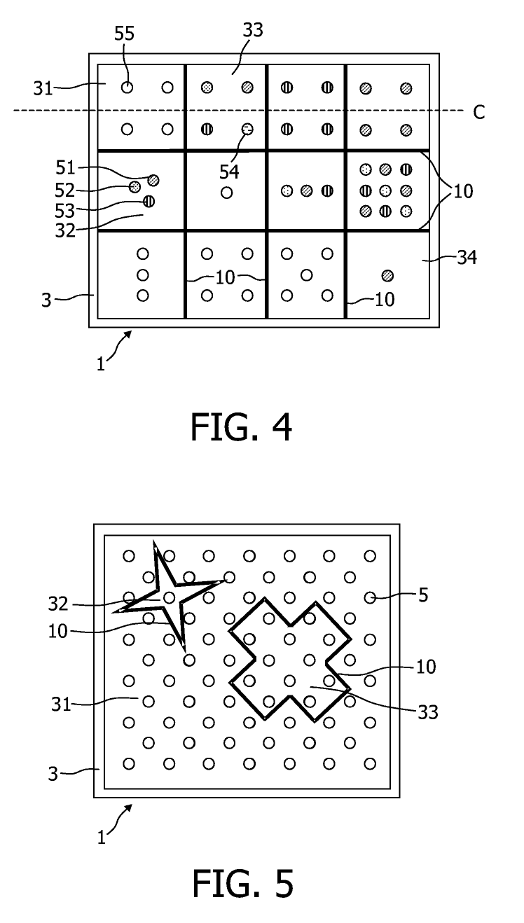

FIG. 3a is a luminance profile in one dimension on line C (FIG. 4), when there are diffusely reflecting separating surfaces.

FIG. 3b is a luminance profile in one dimension on line C (FIG. 4), when there are specularly (=non-diffusely) reflecting separating surfaces.

FIG. 4 is a plan view of a lighting device according to the invention not having a diffuser surface and having different arrangements of light sources.

FIG. 5 is a plan view of a lighting device according to the invention not having a diffuser surface and having different separating surfaces.

FIG. 1a shows plan views of a lighting device 1 having a planar arrangement of light sources 5 in a light distributing device 3 that encloses a volume of space 30. In the left-hand half of the Figure the lighting device 1 is shown without a diffuser surface 4 while in the right-hand half of the Figure the diffuser surface 4 is arranged above the light sources 5. In the latter case the light sources 5, which are not directly visible, are indicated by dashed lines, simply to assist comprehension. The diffuser surface, being evenly shaded, is intended to show the uniform illumination of the diffuser surface that is produced by a suitable light distributing device 3. FIG. 1b is a view of the same lighting device from the side, in section on plane of section A (see FIG. 1a). The nature of the light sources, being for example conventional incandescent bulbs, discharge lamps or electroluminescent light sources (LED's), affects simply the design of the light distributing device and not the invention. The embodiments having LED's as light sources that are described below by way of example are not to be construed as limiting the lighting device according to the invention to light sources of this type.

FIG. 1b is a view of the lighting device 1 from the side, in section on the plane of section A indicated in FIG. 1a. The light is emitted in a conical shape by the light sources 5, and the purpose for which the light distributing device 3 is provided is to distribute this light uniformly, in a volume of space 30, by overlapping the cones of light and by reflection at the inside faces of the light distributing device 3. Depending on the form taken by the light source, the emitted light may also conform to patterns of emission other than the conical shape. Depending on the form they take, the intensities of the individual light sources may be set in dependence on one another and/or independently of one another. Some of the light emitted by the light sources 5 reaches the diffuser surface 4 without being reflected (lines 7) and some reaches it after being reflected at an inside face of the light distributing device 3 (line 8) and the light is all diffusely scattered by the diffuser surface 4 (arrows 9). In preferred embodiments, the reflection at the inside faces of the light distributing device is specular (same angles of incidence and reflection on the macroscopic scale; opposite of diffuse) but in many embodiments it may also be diffuse.

FIG. 2a shows an embodiment of lighting device 1 according to the invention having a distribution of light sources 51 and 52. The light sources 51 and 52 may differ in this case in respect of the nature of the light source and/or in respect of its color of emission, being for example red light sources 51 and green light sources 52. In addition, it would also be possible for the intensities of the light sources 51 and 52 to be differently settable. The separating surface 10 that is inserted in the light distributing device 1 divides the volume of space in the light distributing device 3 into two sub-regions 31 and 32. The separating surface may be added to the light distributing device in a reversible manner, by means of clamped or screwed connections for example, or it may be permanently fastened to the light distributing device, by means of soldered or bonded connections for example. For reasons of clarity, the left-hand half of the Figure shows the lighting device according to the invention without a diffuser surface. Once the light distributing device 3 has been fitted with the separating surface 10, the diffuser surface 4 is arranged again on the light distributing device. In the right-hand half of the Figure the light sources 51 and 52, which are not directly visible, have been indicated in broken lines to assist comprehension. The diffuser surfaces 41 and 42, being evenly shaded, are intended to show the uniform illumination of the diffuser surface that is produced in the sub-regions 31 and 32 respectively by a suitable light distributing device. The light emitted by the light sources 51 and 52 emerges from the lighting device in the regions 41 and 42 of the diffuser surface 4 with the differences caused by the nature of the light sources and the way in which they are driven electronically, which is represented here by the different shadings for the sub-regions 41 and 42. With light sources 51 that are red for example, the region 41 will give red light and with light sources 52 that are green, the region 42 will give green light. Depending on the form taken by the separating surface 10, the transition from the red region 41 to the green region 42 may for example appear to be non-existent, continuous or having a dark separating region. In a preferred embodiment (see FIG. 2b), the separating surface 10 separates the regions 31 and 32 from one another in a light-tight manner. In an even more preferred embodiment, the separating surface is made of a specularly reflecting material, which means that the light originally emitted by the light sources 51 and 52 (lines 7 in FIG. 1b) is reflected by the separating surface in the direction of the diffuser surface 4 (lines 81 and 82) and at the diffuser surface 4 is diffusely scattered (arrows 9) in the regions 41 and 42. In a particularly preferred embodiment, the thickness of the separating surface is smaller than the thickness of the diffuser surface so that, when the lighting device 1 is operating, the separating surface will not be visible to an observer. Typical thicknesses for diffuser surfaces are a few millimeters, whereas metal separating surfaces for example can be produced with thicknesses of less than 1 mm. Depending on the form taken by the separating surface, the transition in color between the regions 41 and 42 may be arranged to be sharp or continuous. In other embodiments, additional light effects may be obtained by means of separating surfaces that separate the regions 31 and 32 in the light distributing device 3 in a way that is partly permeable to light, for example by means of holes, slots or other openings that are present in the separating surface. What are obtained with these embodiments are unsharp transitions in color and/or intensity between the sub-regions in the region of the separating surface.

FIGS. 3a and 3b show luminance profiles in one dimension across a sub-region of a light distributing device, for a lighting device having a diffuser surface, as plotted on line C in FIG. 2 for sub-region 33. The light sources in the adjoining regions are switched off in this example. In FIG. 3a the reflecting surfaces of the separating surfaces 10 are made of a diffusely reflecting material. As a result, an increased intensity is produced in the region of the separating surface, which can also be perceived by an observer through the diffuser surface. FIG. 3b shows a corresponding intensity profile for a lighting device having specularly reflecting surfaces for the separating surfaces. The intensity profile does not show any increase in intensity in the region of the separating surfaces in the sub-region 33. The steepness of the decline in intensity at the point where the side-wall is situated is a function of the nature of the diffuser surface, such for example as its thickness, transmission and its scattering power. In a particularly preferred embodiment having separating surfaces that are not visible to the observer, at least the surfaces of the separating surfaces are made of a specularly reflecting material.

FIG. 4 shows, by way of example, various arrangements of light sources in a lighting device according to the invention that, if operated in the appropriate way, is able to produced different colored effects. In this case, a plurality of regions are separated from one another in a light-tight manner by a plurality of separating surfaces 10 in a light distributing device 3. Region 31 is fitted for example with white light sources 55, region 32 is fitted with one red (51), one green (52) and one blue (53) light source to generate white light by means of the mixing of light, region 33 is fitted in addition with an orange light source 53 to improve the color rendering index, and region 34 is fitted with a red light source to generate red light. Depending on the form taken by the light distributing device 3, light of uniform intensity and color can be produced for the individual sub-regions in the light distributing device 3 that are produced by the separating surfaces 10, independently of one another. In the case of separating surfaces that are mounted in the light distributing device in a reversible manner, the light effects obtained can be varied as desired by the user.

FIG. 5 shows possible embodiments of separating surfaces 10 in a lighting device 1 which divide the light distributing device 3 into sub-regions 31, 32 and 33. Other geometrical forms are also possible for separating surfaces, provided they can be inserted in the relevant arrangement of light sources 5 in the light distributing device 3. The light sources denoted by reference numerals 51 to 55 in the previous FIGS. 2a, 2b and 4 are denoted in general in FIG. 5 by reference numeral 5, because it is not the intention in this case to go into any differences there may be between the light sources.

In accordance with the invention, separating surfaces that produce light distribution by multiple reflection can also be used in light distributing devices. In this case, at least the surface of the separating surfaces is preferably composed of a highly reflective material, such for example as Alanod having a reflectivity equal or greater than 95%, particularly if, to reduce its overall depth, the light distributing device is intended to emit light substantially parallel to the diffuser surface. Light emission substantially parallel to the diffuser surface can be implemented by means of laterally emitting light sources, such as Luxeon LED's for example, or by means of suitable devices that, looking in the direction of emission, are arranged above the light sources. It is even more preferable if the separating surface is made of the same high reflective material as the reflective inside faces of the light distributing device.

The embodiments that have been elucidated by means of the drawings and the description represent only example of a lighting device and are not to be construed as limiting the claims to these examples. Alternative embodiments are also possible for the person skilled in the art, and these too are covered by the scope of protection of the claims. The numbering of the dependent claims is not intended to imply that other combinations of the claims do not also represent advantageous embodiments of the invention.

1. A lighting device having at least two light source and in particular LED's, having a light distributing device for distributing the light emitted by the light sources, the light sources being arranged inside the light distributing device, having a diffuser surface arranged on the light distributing device and having at least one separating surface arranged inside the light distributing device to divide the light distributing device into at least two sub-regions for light distribution, which sub-regions may be as desired.

2. A lighting device as claimed in claim 1, characterized in that the separating surface is added to a light distributing device and can be exchanged.

3. A lighting device as claimed in claim 1, characterized in that at least two light sources are provided to emit light of intensities that can be set independently of one another.

4. A lighting device as claimed in claim 3, characterized in that at least two light sources are provided to emit light in different regions of the spectrum.

5. A lighting device as claimed in claim 1, characterized in that the thickness of the separating surface is smaller than the thickness of the diffuser surface.

6. A lighting device as claimed in claim 1, characterized in that the separating surface has regions, in particular holes and/or slots, that are permeable to light, for an exchange of light between the sub-regions.

7. A lighting device as claimed in claim 5, characterized in that the separating surface separates the sub-regions in a substantially light-tight manner.

8. A lighting device as claimed in claim 1, characterized in that the light distributing device and the separating surface are at least partly composed of materials having a reflectivity of more than 90%, to enable the light emitted by the light sources to be distributed by multiple reflection.

9. A lighting device as claimed in claim 8, characterized in that, looking in the direction of emission of the lighting device, there is arranged above the light source a device that deflects the light emitted by the light source substantially parallel to the diffuser surface.

10. A lighting device as claimed in claim 1, characterized in that the separating surface is so arranged that at least three light sources, and in particular three light sources that emit in different colors at intensities that can be set independently of one another, are arranged in each sub-region.

11. A lighting device as claimed in claim 1, characterized in that the diffuser surface has a light transmission of between 40% and 60%.
